(19) United States
(12) Patent Application Publication
(10) Pub. No.: US 2026/0274376 A1
(43) Pub. Date: Sep. 17, 2026

(54) AN APPARATUS, METHOD AND SYSTEM FOR GENERATING AIR BUBBLES

(71) Applicant: NOBUYOSHI MORIMOTO, Tokyo (JP)

(72) Inventor: NOBUYOSHI MORIMOTO, Tokyo (JP)

(21) Appl. No.: 19/161,953

(22) PCT Filed: Mar. 1, 2024
(86) PCT No.: PCT/IB2024/052011

§ 371 Date: Sep. 3, 2025

(30) Foreign Application Priority Data
Mar. 3, 2023 (IN) 202311014502

(51) Int. Cl. B63B 1/38

(52) U.S. Cl. CPC B63B 1/38; B63B 2001/387

(57) ABSTRACT

The present invention provides an apparatus for generating air bubbles is disclosed. The apparatus comprises an at least one wind sail (104) configured to direct air flow into a vessel (100). The apparatus also comprises an at least one first vertical elongated conduit (108) operatively coupled to the at least one wind sail (104) for receiving the air flow directed by the at least one wind sail (104). The apparatus further comprises an at least one horizontal elongated conduit (116) operationally coupled to the vertical elongated conduit (108) for increasing the air flow there within horizontal elongated conduit (116), wherein the increased air flow is capable of generating energy. Further, the apparatus also comprises an at least one second vertical elongated conduit (120) configured to direct the increased air flow to an air bubble generating mechanism (122). The air bubble generating mechanism (122) operationally coupled to the second vertical elongated conduit (120), wherein the air bubble generating mechanism (122) create a layer of air bubbles adjacent submerged region of the vessel (100) and thereby enhancing speed of the vessel (100).

### FIELD OF THE INVENTION

The present invention generally relates to enhancing speed of a vessel. More specifically, the present invention relates to creating a film or layer of bubbles adjacent the submerged region of the vessel for effectively reducing frictional resistance of the vessel.

### BACKGROUND OF THE INVENTION

Vessels such as ships, yachts, boats or the like travel in various water bodies, including but not limited to oceans, canals, rivers and other deep water bodies, and carry cargo or passengers. As generally understood, the vessel travels in a medium that provides more drag resistance as compared to land used vehicles. The drag resistance refers to the energy required to push water out of the way of the vessel. The drag resistance not only reduces speed of the vessel but also increases fuel consumption of the vessel.

When a vessel is sailing, a turbulent boundary layer is developed on or below the waterline along the surface of the hull. Accordingly, a frictional resistance is exerted on the surface of the hull, thereby reducing the propulsive performance of the vessel. Further, there is a problem how the propulsive performance is reduced in a vessel sailing on the ocean and rivers, which receives various disturbances, such as waves and streams, and receives influences owing to freight conditions and navigational conditions.

Conventionally, there have been a number of know techniques which are related to smooth sailing of the vessel while reducing frictional resistance between the water waves and ship's hulk. Such conventional general type are known in the art and are exemplified by the following patents and publication:

JP 2004 188993 discloses that a sensor is provided at the bottom of a ship's hull and detects the emitted air bubbles. The sensor is fitted at a position to provide detection of the air bubbles. Particularly, signals of the sensors are inputted into a hull movement measuring unit, in which wave information/relative wave information, detections of ship acceleration, wind direction are inputted. However, such a conventional art is not economically fit to provide enhanced vessel speed.

Another patent document discloses a technical idea that adjusts fuel adjustment means and gas drawing rate adjustment means to reduce fuel consumption while drawing exhaust gas from a turbocharger and injecting the gas into water to reduce frictional resistance, and adjusts the flow rate of the exhaust gas so as to minimize the amount of fuel supply as a control. However, the idea disclosed in such a patent document only controls the drawing rate so as to reduce the amount of fuel supply to a main engine with respect to a prescribed vessel velocity. The optimal control is not necessarily realized. Further, it fails to reduce effective resistance at the bow section of the vessel.

Yet another patent document discloses a technical idea that provides a drawing port at a low pressure spot of a turbocharger compressing gas for a main engine and releases the drawn gas into water. Although the idea disclosed in such a patent document refers to a valve for adjusting the flow rate, the idea discloses no specific technique to reduce frictional resistance.

Yet another patent document discloses a technical idea that provides a branch line for a compressed air line of a turbocharger provided at a main engine, draws scavenged gas from a spot downstream from the intercooler and discharges bubbles. However, this idea discloses no specific control method either, and has a possibility of adversely affecting the operation of the main engine, thereby failing to provide enhanced speed of the vessel.

Yet another patent document discloses a technical idea of a turbo compound system (exhaust gas passes through the blower turbine and the blower blows the gas to discharge bubbles) that branches exhaust gas out of a main engine, provides a turbine at a branch line, causes the turbine to drive a blower to discharge bubbles from the hull. However, the idea discloses no specific control method, and fails to provide effective propulsive performance of the vessel.

Yet another patent document provides the hull with an air injection unit injecting air from a nozzle via an air injection control unit, provides a sensor detecting air bubbles or an air sheet released there from at the bottom of the hull, inputs signals from the sensor into the hull operation measurement unit, inputs wave information, relative wave information, displacement, movement velocity, acceleration, a direction, detected conditions of bubbles, a wind velocity and a wind direction into the hull operation measurement unit, detects bubble conditions on the basis of bottom of the vessel pressure information, bubble distribution information, frictional force information and hull resistance information, and optimally controls the released air layer and the bubble conditions. Since such a configuration is adopted, various pieces of detected information are limited. The control is not performed by determination of navigational situations, such as the relative velocity between the vessel and the water and the draft conditions, and vessel situations, such as operating conditions of the vessel and the engine conditions. This cannot appropriately control the generation of air bubbles and effectively reduce the frictional resistance. Further, this does not control the number of air injection units according to various pieces of detection information.

Yet another patent document discloses ideas that controls the supply of pressurized gas and exhaust gas according to pressure and the draft, supply the gas when the pressure rises to a certain degree and exceeds a pressure determined by a depth of water of protruding (injecting) and stop the gas when the pressure decreases. However, these documents do not disclose or suggest an idea that effectively reduces resistance of the vessel.

Yet another patent document discloses a technical idea that pertains to a micro bubble injecting device, integrally forms a fluid guide plate, which guides bubble-water mixture fluid aft, at the front end of a fluid nozzle provided at the hull, and converts it to kinetic energy when the bubble-water mixture fluid is injected into propulsion of the vessel. However, the idea disclosed in such a patent document is incapable of preliminarily determining the direction of the fluid to be injected. Further, there is a possibility that the fluid guide plate itself becomes a resistance preventing the vessel from sailing. However, as such there is no disclosure about generation of an unconfined layer of air bubbles to reduce resistance of the vessel.

In view of the above limitations of numerous innovations in relation to conventional air bubble generation techniques have been provided suitable for the specific individual purposes to which they address, while having different structure or operation as compared to the present subject matter. Thus, there exists a need to develop an improved device, which would in turn address a variety of issues including, but not limited to, challenges related to frictional resistance acting on the bottom surface of the vessel to be effectively reduced.

The above-described deficiencies of conventional approaches and method thereof, are merely intended to provide an overview of some of the problems of conventional approaches and are not intended to be exhaustive. Other problems with conventional approaches, and methods and their corresponding benefits of the various non-limiting embodiments described herein may become further apparent upon review of the following description.

### SUMMARY OF THE INVENTION

The following presents a simplified summary of the invention to provide a basic understanding of some aspects of the invention. This summary is not an extensive overview of the present invention. It is not intended to identify the key/critical elements of the invention or to delineate the scope of the invention. Its sole purpose is to present some concept of the invention in a simplified form as a prelude to a more detailed description of the invention presented later.

In one implementation, an apparatus for generating air bubbles is disclosed. The apparatus comprises at least one wind sail configured to direct air flow into a vessel while the vessel is navigating in desired direction. In one embodiment, the at least one wind sail is configured to receive wind from any direction, such as wind direction from tailwind, against wind, side wind, and the like. The apparatus also comprises at least one first vertical elongated conduit operatively coupled to at least one wind sail for receiving the air flow directed by at least one wind sail, the elongated conduit having a plurality of slots for receiving the air flow directed from at least one wind sail. The apparatus further comprises at least one horizontal elongated conduit operationally coupled to the vertical elongated conduit for increasing the air flow within horizontal elongated conduit, wherein the increased air flow is capable of generating energy. Further, the apparatus also comprises at least one second vertical elongated conduit operationally coupled to the horizontal elongated conduit and configured to direct the increased air flow to an air bubble generating mechanism. The air bubble generating mechanism operationally coupled to the second vertical elongated conduit, wherein the air bubble generating mechanism is to create a layer of air bubbles adjacent a submerged region of the vessel and thereby enhance speed of the ship.

In another implementation, the air flow corresponds to a group comprising head wind, side wind, and tail wind.

In yet another implementation, a rotatable apparatus to alter direction of a port side and a starboard side of the vessel.

In yet another implementation, an internal portion of the first vertical elongated conduit comprises a threaded portion to provide unidirectional air flow in downward direction to the horizontal elongated conduit.

In yet another implementation, the horizontal elongated conduit is divided into an upper segment, middle segment, and a lower segment to direct the increased air flow to second vertical elongated conduit.

In yet another implementation, each segment of the horizontal elongated conduit comprises at least one conversion device capable of converting energy driven from the air flow to electrical energy.

In yet another implementation, a method for generating air bubbles is disclosed. The method comprises the step of directing, by at least one wind sail, air flow into the vessel. The method further comprises the step of receiving, by a first vertical elongated conduit operatively coupled to the at least one sail, the air flow directed by the at least one sail, wherein the elongated conduit having a plurality of slots for receiving the air flow directed from the at least one sail. Furthermore, the method comprises the step of increasing, by a horizontal elongated conduit operationally coupled to the vertical elongated conduit, the air flow within horizontal elongated conduit, wherein the increased air flow is capable of generating energy. Thereafter, the method comprises the step of directing, by a second vertical elongated conduit operationally coupled to the horizontal elongated conduit, the increased air flow near bottom portion of the vessel. Finally, the method comprises the step of receiving, by an air bubble generating mechanism operationally coupled to the second vertical elongated conduit, wherein the air bubble generating mechanism is to create a layer of air bubbles adjacent a submerged region of the vessel and thereby enhance speed of the ship.

In yet another implementation, a system for generating air bubbles is disclosed. The method comprises a repository having a hardware processor and a memory communicatively coupled to the hardware processor, wherein the memory stores the hardware processor instructions, wherein the repository is configured to store instructions related to generating air bubbles near a bow area of a vessel. The system further comprises an air flow manager configured to direct air flow into the vessel. The air flow manager further receives the air flow into at least first vertical elongated conduit, wherein the first vertical elongated conduit has a plurality of slots to receive the air flow. Furthermore, the air flow manager increases the air flow there within a horizontal elongated conduit, wherein the increased air flow is capable of generating energy. Thereafter, the air flow manager direct the increased air flow to at least first vertical elongated conduit, wherein the at least first vertical elongated conduit further directs the increased air flow near bottom portion of the vessel. Further, the air flow manager receives the increased air flow for creating a layer of air bubbles adjacent a submerged region of the vessel and thereby enhancing speed of the ship. The system also comprises a risk control manager configured to receive inputs from the air flow manager. The risk control manager further performs analysis by employing at least one of artificial intelligence technique on the received inputs. Thereafter, the risk control manager generates a suggestive report to provide an optimum solution to control the air flow.

### Objectives

Some of the objects of the present disclosure, which at least one embodiment herein satisfies, are as follows:

An object of the present invention is to provide a system equipped within a vessel that can easily sail through a rough sea condition.

Another objective of the present invention is to provide an air bubble generating mechanism which reduces drag resistance on the vessel, thus improving the speed and fuel efficiency of the vessel.

Yet another objective of the present invention is to provide the air bubbles flow at a bottom of the vessel to create a layer of air bubbles between the bottom of the vessel and seawater.

Yet another objective of the present invention is to effectively reduce frictional resistance by appropriately injecting bubbles without any disturbance, and further utilize an effect of generation of the bubbles for smooth sailing of the vessel.

Yet another objective of the present invention is to provide a frictional resistance reduction apparatus for a vessel that is capable of reducing the frictional resistance without necessity of further generating energy for generating bubbles and reducing consumption of energy according thereto.

Yet another objective of the present invention is to provide techniques that inject bubbles from the hull, thus improving the speed and fuel efficiency of the vessel.

Yet another objective of the present invention is to provide an apparatus for a vessel that maintains high efficiency without adversely affecting the operation of the main engine while generating bubbles using renewable source of energy.

Other aspects, advantages, and salient features of the invention will become apparent to those skilled in the art from the following detailed description, which, details the invention in different embodiments.

### BRIEF DESCRIPTION OF THE DRAWINGS

While the specification concludes with claims that particularly point out and distinctly claim the invention, it is believed that the advantages and features of the present invention will become better understood with reference to the following more detailed description of expressly disclosed exemplary embodiments taken in conjunction with the accompanying drawings. The drawings and detailed description which follow are intended to be merely illustrative of the expressly disclosed exemplary embodiments and are not intended to limit the scope of the present invention as set forth in the appended claims. In the drawings:

FIG. 1 illustrates a schematic view of bow section in which an air bubbles generating mechanism injecting air bubbles above a bottom of the vessel adopted in an embodiment of the invention;

FIG. 1a illustrates a schematic side view of the horizontal elongated conduit adopted in an embodiment of the invention; and

FIG. 1b illustrates a schematic side view of an accommodator adopted in an embodiment of the invention.

### LIST OF REFERENCE NUMERALS

100 Vessel
102 Accommodator Area
104 Wind Sail
106 Rotatable Apparatus
108 First Vertical Elongated Conduit
110 Plurality of slots
112 Additional elongated conduit
114 Emergency valve
116 Horizontal Elongated Conduit
118 Anti-back pressure valve
120 Conversion Device
122 Second vertical elongated conduit
124 Air Bubble Generating mechanism

### DETAILED DESCRIPTION OF THE INVENTION

Embodiments, of the present disclosure, will now be described with reference to the accompanying drawing.

The exemplary embodiments described herein detail for illustrative purposes are subject to many variations in the structure and composition. It should be emphasized, however, that the present invention is not limited to a particular composition as shown and described herein. It is understood that various omissions and substitutions of equivalents are contemplated as circumstances may suggest or render expedient, but these are intended to cover the application or implementation without departing from the scope of the claims of the present invention. Also, it is to be understood that the phraseology and terminology used herein is for the purpose of description and should not be regarded as limiting.

The use of terms “including,” “comprising,” or “having” and variations thereof herein; are meant to encompass the items listed thereafter and equivalents thereof as well as additional items. Further, the use of the expression “at least” or “at least one” suggests the use of one or more elements or ingredients or quantities, as the use may be in the embodiment of the disclosure to achieve one or more of the desired objects or results. Further, the terms, “an” and “a” herein do not denote a limitation of quantity, but rather denote the presence of at least one of the referenced item. Furthermore, the term “may” herein is used in a permissive sense (i.e. meaning having the potential to), rather than the mandatory sense, (i.e. meaning must).

Further, as used in the following, the terms “preferably”, “more preferably”, “particularly”, “more particularly”, “specifically”, “more specifically” or similar terms are used in conjunction with optional features, without restricting alternative possibilities. Thus, features introduced by these terms are optional features and are not intended to restrict the scope of the claims in any way. The invention may, as the skilled person will recognize, be performed by using alternative features. Similarly, features introduced by “in an embodiment of the invention” or similar expressions are intended to be optional features, without any restriction regarding alternative embodiments of the invention, without any restrictions regarding the scope of the invention, and without any restriction regarding the possibility of combining the features introduced in such way with other optional or non-optional features of the invention.

The following detailed description illustrates the invention by way of example, and not by way of limitation. This description will clearly enable one skilled in the art to make and use the invention and describes several embodiments, adaptions, variations, alternatives, and uses of the invention, including what we presently believe is the best mode of carrying out the invention.

The present invention provides a low cost and high quality air bubble generating mechanism that facilitates air bubbles flow at bottom of a vessel (100) to create a layer of air bubbles between bottom of the vessel (100) and seawater. This can realize reduction in frictional resistance of the vessel (100) in the optimal efficiency adapted to variations such as those in the relative velocity between water and the hull, the draft of the vessel (100), the inclination of the hull and the sheer force acting on the hull.

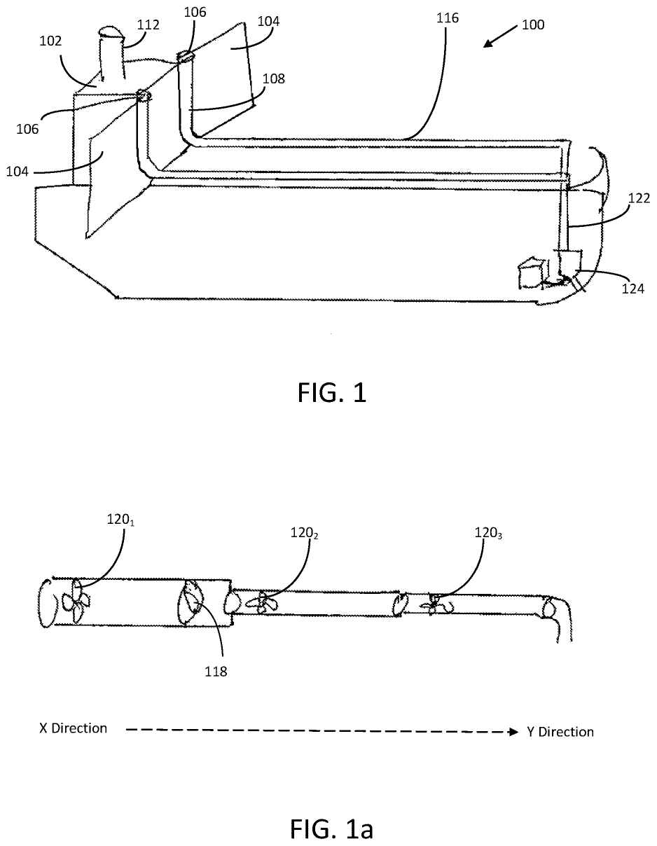

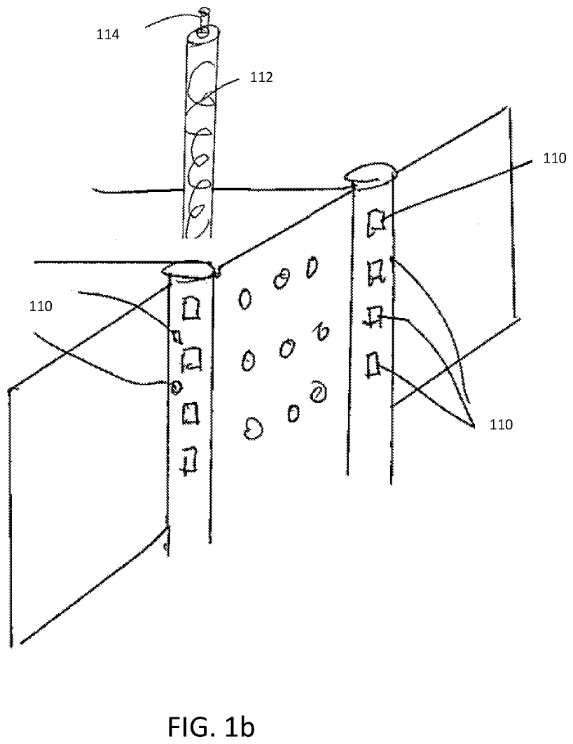

Referring to FIG. 1, the present invention illustrates a schematic side view of bow section in which an air bubbles generating mechanism creating air bubbles at bottom of the vessel (100). The vessel (100) may be but not limited to a cargo ship, a passenger ship, a defense ship, a research ship or a fishing ship. The vessel (100) may comprises an accommodator area (102) that may correspond to a living space where cabins for ship's crew are generally located, along with galley, provision stores, meeting rooms, lockers, etc. The accommodation area (102) is usually in stern part of the ship. Further, the vessel may comprise apparatus having at least one wind sail (104) which may be installed at the windward side of the accommodation area. In one embodiment, the at least one wind sail (104) is configured to receive wind from any direction, such as wind direction from tailwind, against wind, side wind, and the like. The at least one wind sail (104) may be configured to direct air flow into the vessel (100). For an instance, the wind sail (104) can be installed at starboard and port side of the vessel (100) to collect the air flow from forward direction while the ship is sailing.

In one case, a rotatable apparatus (106) may be installed at the accommodation area (102) to alter direction of a port side and a starboard side of the vessel (100). Particularly, the rotatable apparatus (106) may be responsible for controlling various directions of the wind sail. It may be noted that the wind sail (104) may be installed at the windward side of the accommodation area (102). In one case, the air flow may correspond to a group comprising head wind, side wind, and tail wind. Further the apparatus may comprise at least one first vertical elongated conduit (108) which may be operatively coupled to the at least one wind sail (104). In one case, the at least one first vertical elongated conduit (108) may receive the air flow via plurality of slots (110) installed within the first vertical elongated conduit (108) (as shown in FIG. 1b). The plurality of slots (110) may be located at front portion or rear portion of the at least vertical elongated conduit (108).

As generally understood, total volume of the air flow is dependent on the constant front air volume plus wind strength during sailing in the environment. In one embodiment, a processing engine (not shown) installed within the accommodator area (102) may determine a set of controlling parameters pertaining to an optimized size of the plurality of slots (110). For an instance, under gusty wind conditions, the set of controlling parameters may provide an optimal solution to control variable direction of wind flow around the vessel (100). It is to be noted that the processing engine may include a machine learning technique, an artificial intelligence technique, a template approach technique, an artificial potential field technique, or the like, or any combination thereof to determine optimized size of the plurality of slots (110) by way of partially or fully covering the plurality of slots (110). In one embodiment, the artificial intelligence technique can also be employed to optimize each slot (110) to produce musical notes. For an instance, artificial intelligence technique may records and measures the air flow for controlling acoustic sound to generate sound like a tuba.

Further, if the wind directions get reversed, the air flow that travels internally within the vessel (100) would also reverse. Therefore, an additional elongated conduit (112), operationally coupled at top of the accommodator area (102), is capable to control the reverse air flow within the vessel (100). Particularly, an emergency air release valve (114), as shown in FIG. 1b, may be installed within the additional elongated conduit (112) to release the air flow back to the environment in case of any emergency situations. Further the apparatus may comprise at least one horizontal elongated conduit (116) may be operationally coupled to the at least first vertical elongated conduit (108) for increasing the air flow there within the at least one horizontal elongated conduit (110). In one case, the at least one horizontal elongated conduit (116) is divided into plurality of segments, particularly, an upper segment, middle segment, and a lower segment. It may be noted that diameter of each segment of the at least one horizontal elongated conduit (116) subsequently decreases while going from x direction to y direction, thereby increasing the air flow within the horizontal elongated conduit (116). Particularly, size of lower segment is smaller than both the upper segment and the middle segment. In one case, the horizontal elongated conduit (116) may comprise an anti-back pressure valve (118) to avoid reverse air flow within the horizontal elongated conduit (116).

It is to be noted that each segment of the horizontal elongated conduit (116) comprises at least one conversion device (120), as shown in FIG. 1b, capable of creating high velocity airflow within the horizontal elongated conduit (116). In one case, the conversion device (120) may be a turbine, jet pump, or the like installed within the each segment of the horizontal elongated conduit (120). The conversion device (120) may convert air flow to mechanical energy, electrical energy, or a combination thereof. The mechanical energy created may include rotation of a turbine blade, a high velocity airflow, or other mechanical energy. Further, the high velocity airflow may be received by a second vertical elongated conduit (122) operationally coupled to the horizontal elongated conduit (116).

In one embodiment volume of the air flow in the vertical pipe depends upon three variables (i) area of the wind sail (104), (ii) Loss ratio and intake volume to the plurality of slots (112) of the vertical elongated conduit (108), (iii) diameter of each elongated conduit (108, 116, 120) and total volume of increased air flow into the horizontal elongated conduit (116.) In one case, formula related to air volume intake within the vessel (100) considering all the above variables, and different gear ratios is as follow:

$$AV = s \times 0.5144 \times 2 w \times n \times pie \times r \times r ,$$

wherein “AV” denotes Air Volume per sec in the horizontal elongated conduit (116), “n” denotes wind take in ratio to vertical elongated conduit (108), “s” is ship speed (knots), “w” denotes width of the horizontal elongated conduit (116), “r” denotes radius of the horizontal elongated conduit (116).

For an instance, assuming n is 0.8, 12 knots speed of ship, and area of the wind sail (104) is of either port or starboard side is 200 sq meter, the value of AV, as per the formula, appears to be 139 cubic meter. If the conversion device's pitch is 10 cm, theoretically, each conversion device (120) within the horizontal elongated conduit (116) can rotate 1390 rpm to produce high velocity airflow. Accordingly, the high velocity airflow thus received by the apparatus may be utilized to generate electrical energy. For an instance, the electrical energy may be utilized by an air bubble generating apparatus (124) to provide the air bubbles at bottom of the vessel (100) to create a layer of air bubbles between the bottom of the vessel (100) and seawater. The air bubble generating apparatus (124) may be operationally coupled at bottom portion of the vessel (100) as illustrated in FIG. 1.

Further, the air bubble generating apparatus (124) may comprise an air blower, an air compressor or any other dedicated system may use to create air bubbles. The air bubble generating apparatus (124) may create a film or layer of bubbles adjacent the submerged region of the vessel. In one embodiment, if the speed of the vessel (100) is slow and accordingly amount of air flow received by the apparatus is subsequently low, then a supplementary air compressor (not shown) may be utilized to provide sufficient air flow to the apparatus for creating adequate amount of air bubbles adjacent the submerged region of the vessel. In one case, the power to the supplementary air compressor may be provided by batteries (coupled to a screw generator) installed within the vessel. Accordingly, due to the layer of the air bubbles, the drag resistance between the vessel (100) and the sea water will reduce. Therefore, speed and fuel efficiency of the vessel (100) increases.

In another implementation, a method for generating air bubbles is disclosed. The method comprises the step of directing, by the at least one wind sail (104), air flow into the vessel (100). The method further comprises the step of receiving, by the first vertical elongated conduit (108) operatively coupled to the at least one sail (104), the air flow directed by the at least one sail (104), wherein the elongated conduit (112) having a plurality of slots (110) for receiving the air flow directed from the at least one sail (104). Furthermore, the method comprises the step of increasing, by the horizontal elongated conduit (116) operationally coupled to the first vertical elongated conduit (108), the air flow there within the horizontal elongated conduit (116), wherein the increased air flow is capable of generating energy. Thereafter, the method comprises the step of directing, by the second vertical elongated conduit (122) operationally coupled to the horizontal elongated conduit (116), the increased air flow near bottom portion of the vessel (100). Finally, the method comprises the step of receiving, by an air bubble generating mechanism (124) operationally coupled to the second vertical elongated conduit (122), the air bubble generating mechanism (124) is to create a film or layer of bubbles adjacent the submerged region of the vessel.

In yet another implementation, a system for generating air bubbles is disclosed. The method comprises a repository having a hardware processor and a memory communicatively coupled to the hardware processor, wherein the memory stores the hardware processor instructions, wherein the repository is configured to store instructions related to generating air bubbles near a bow area of a vessel (100). The system further comprises an air flow manager configured to direct air flow into the vessel (100). The air flow manager further receive the air flow into at least first vertical elongated conduit (108), wherein the first vertical elongated conduit (108) have a plurality of slots (110) to receive the air flow. Furthermore, the air flow manager is capable of increasing the air flow there within the horizontal elongated conduit (116), wherein the increased air flow is capable of generating energy.

Thereafter, the air flow manager direct the increased air flow to at least first vertical elongated conduit (108), wherein the at least first vertical elongated conduit (108) further directs the increased air flow near bottom portion of the vessel (100). Further, the air flow manager receive the increased air flow for generating air bubbles near a bow area of the vessel (100). The system also comprises a risk control manager configured to receive inputs from the air flow manager. The risk control manager further perform analysis by employing at least one of artificial intelligence technique on the received inputs. Thereafter, the risk control manager generate a suggestive report to provide an optimum solution to control the air flow. In one scenario, if the speed of the vessel is slow and accordingly the received air flow is low than a predetermined value, the risk control manager activates a supplement air compressor (not shown) to ensure sufficient air bubbles to be generated constantly. Additionally, the supplement air compressor also prevents back pressure from generating sufficient air bubbles near bow of the vessel.

The foregoing descriptions of exemplary embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated. It is understood that various omissions, substitutions of equivalents are contemplated as circumstance may suggest or render expedient, but is intended to cover the application or implementation without departing from the spirit or scope of the claims of the present invention.

### TECHNICAL ADVANCEMENTS

The present invention described herein; above has several technical advantages including, but not limited to, enhancing the speed and fuel efficiency of the vessel that:
ensure minimal drag resistance on the vessel while injection bubbles to the bottom of the vessel
optimum stability of the vessel while governing high wind velocities;
easy to use and economical in nature;
results into inexpensive setup;
ensuring constant air bubble generation even during slow speed of the vessel; and
performs analysis based on artificial intelligence.

The embodiments herein and the various features and advantageous details thereof are explained with reference to the non-limiting embodiments in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation.

1. A apparatus for generating air bubbles comprising:
at least one wind sail configured to direct an air flow into a vessel;
at least one first vertical elongated conduit operatively coupled to the at least one wind sail for receiving the air flow directed by the at least one wind sail, the elongated conduit having a plurality of slots for receiving the air flow directed from the at least one wind sail;
at least one horizontal elongated conduit operationally coupled to the vertical elongated conduit for increasing the air flow there within horizontal elongated conduit, wherein the increased air flow is capable of generating energy;
at least one second vertical elongated conduit operationally coupled to the horizontal elongated conduit and configured to direct the increased air flow to an air bubble generating mechanism;
wherein the air bubble generating mechanism operationally coupled to the second vertical elongated conduit, wherein the air bubble generating mechanism is to create a film or layer of bubbles adjacent a submerged region of the vessel and thereby enhancing speed of the vessel.

2. The apparatus as claimed in claim 1, wherein the air flow corresponds to a group comprising head wind, side wind, and tail wind.

3. The apparatus as claimed in claim 1, further comprises a rotatable apparatus to alter direction of a port side and a starboard side of the vessel.

4. The apparatus as claimed in claim 1, wherein an internal portion of the first vertical elongated conduit comprises a threaded portion to provide unidirectional air flow in downward direction to the horizontal elongated conduit.

5. The apparatus as claimed in claim 1, wherein the horizontal elongated conduit is divided into an upper segment, middle segment, and a lower segment to direct the increased air flow to the second vertical elongated conduit.

6. The apparatus as claimed in claim 5, wherein each segment of the horizontal elongated conduit comprises at least one conversion device capable of converting energy driven from the air flow to electrical energy.

7. A method for generating air bubbles, the method comprising:
directing, by at least one wind sail, an air flow into the vessel;
receiving, by a first vertical elongated conduit, the air flow directed by the at least one sail, wherein the elongated conduit comprises the plurality of slots for receiving the air flow;
increasing, by a horizontal elongated conduit, the air flow there within horizontal elongated conduit, wherein the increased air flow is capable of generating energy;
directing, by a second vertical elongated conduit, the increased air flow at bottom portion of the vessel; and
receiving, by an air bubble generating mechanism, the increased air flow for creating a layer of air bubbles adjacent a submerged region of the vessel and thereby enhancing speed of the vessel.

8. A system for generating air bubbles, the system comprising:
a repository having a hardware processor and a memory communicatively coupled to the hardware processor, wherein the memory stores the hardware processor instructions, wherein the repository is configured to store instructions related to generating air bubbles at bottom portion of a vessel;
an air flow manager configured to:
direct air flow into the vessel;
receive the air flow into at least first vertical elongated conduit, wherein the first vertical elongated conduit have the plurality of slots to receive the air flow;
increase the air flow there within the horizontal elongated conduit, wherein the increased air flow is capable of generating energy;
direct the increased air flow to the at least first vertical elongated conduit, wherein the at least first vertical elongated conduit further directs the increased air flow near bottom portion of the vessel;
receive the increased air flow for creating a layer of air bubbles adjacent a submerged region of the vessel and thereby enhancing speed of the vessel;
a risk control manager configured to:
receive inputs from the air flow manager;
perform analysis by employing at least one of artificial intelligence technique on the received inputs; and
generate a suggestive report to provide an optimum solution to control the air flow.

9. The system as claimed in claim 8, wherein the risk control manager is configured to activate a supplementary air compressor if the received air flow is lower than a predetermined value.
